(19) United States
(12) Patent Application Publication
(10) Pub. No.: US 2008/0079539 A1
(43) Pub. Date: Apr. 3, 2008

(54) Friends Finder Service for a Mobile Device in a Network

(76) Inventors: Robert C. Daley, Nashua, NH (US); Eugene Wang, Laguna Niguel, CA (US); Sunil Marolia, Laguna Niguel, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/839,396

(22) Filed: Aug. 15, 2007

Related U.S. Application Data
(60) Provisional application No. 60/838,081, filed on Aug. 15, 2006.

(51) Int. Cl. H04Q 7/08

(52) U.S. Cl. 340/7.29

(57) ABSTRACT

A method and system for interfacing to an electronic device is disclosed. A service provider may receive a request from the electronic device to determine whether any of the specified mobile terminals may be within a specified range of the electronic device. The range may be a default value and/or specified by a user of the electronic device. The service provider may communicate to the electronic device whether any of the specified mobile terminals may be within the specified range. If so, the service provider may communicate information regarding the location of the mobile terminals within range. The service provider may also communicate to the electronic device a map on which the mobile terminals may be placed.

The present application makes reference to, claims priority to, and claims benefit of U.S. Provisional Application Ser. No. 60/838,081 entitled “FRIENDS FINDER SERVICE FOR A MOBILE DEVICE IN A NETWORK,” filed Aug. 15, 2006, the complete subject matter of which is hereby incorporated herein by reference, in its entirety.

### BACKGROUND OF THE INVENTION

Electronic devices, such as, for example, mobile phones and personal digital assistants (PDA's), may comprise a list of contacts, such as, for example, friends, family, and/or business contacts. The contact information may comprise, for example, name, phone number, address, and email address. Accordingly, a user of the contact list may select a contact to call and/or send an email. Or, when a call is received, the electronic device may display a name associated with that number.

Further limitations and disadvantages of conventional and traditional approaches will become apparent to one of skill in the art, through comparison of such systems with the present invention as set forth in the remainder of the present application with reference to the drawings.

### BRIEF DESCRIPTION OF SEVERAL VIEWS OF THE DRAWINGS

FIG. 1A is a diagram of an exemplary network that supports a contacts finder service, in accordance with an embodiment of the invention.

FIG. 1B is a perspective block diagram of a network that is capable of supporting a contacts finder service, in accordance with an embodiment of the invention.

FIG. 2 is a flow chart of exemplary steps for using a contacts finder service, in accordance with an embodiment of the invention.

FIG. 3A is a perspective block diagram of an exemplary menu for use with a contacts finder service, in accordance with an embodiment of the invention.

FIG. 3B is a perspective block diagram of an exemplary registration menu for use with a contacts finder service, in accordance with an embodiment of the invention.

FIG. 3C is a perspective block diagram of an exemplary preferences menu for use with a contacts finder service, in accordance with an embodiment of the invention.

FIG. 3D is a perspective block diagram of an exemplary contact entry menu for use with a contacts finder service, in accordance with an embodiment of the invention.

FIG. 3E is a perspective block diagram of an exemplary contact management menu for use with a contacts finder service, in accordance with an embodiment of the invention.

FIG. 3F is a perspective block diagram of an exemplary menu for use with a contacts finder service, in accordance with an embodiment of the invention.

FIG. 3G is a perspective block diagram of an exemplary menu that displays nearby contacts, in accordance with an embodiment of the invention.

FIG. 3H is a perspective block diagram of an exemplary menu displaying a location of a nearby contact, in accordance with an embodiment of the invention.

FIG. 4 is a flowchart of an exemplary method to register a new user, in accordance with an embodiment of the invention.

FIG. 5 is a flowchart of an exemplary method to verify a contact list for a user, in accordance with an embodiment of the invention.

FIG. 6 is a flowchart of an exemplary method for a user to determine whether any contacts are nearby when the contact is able to determine its own position, in accordance with an embodiment of the invention.

FIG. 7 is a flowchart of an exemplary method for determining location of a nearby contact when the contact is not able to determine its own position, in accordance with an embodiment of the invention.

### DETAILED DESCRIPTION OF THE INVENTION

Aspects of the present invention relate generally to the personalization of mobile devices, and, more specifically, to a friends or contacts finder service for a mobile device in a network. While the following discussion focuses primarily on mobile terminals such as, for example, a mobile handset, a cellular phone, a personal digital assistant, a pager, and a handheld personal computer, this is by way of example and not by way of specific limitations of the present invention. The teachings contained herein may also be applicable to a variety of other electronic devices for which friends finder service may be desirable, and also where a user of the electronic device may wish to receive promotions/advertisements regarding items/events of interest to the user.

Representative embodiments of the invention may be employed for finding persons who may be near the electronic device. The electronic device may use wired or wireless communication links such as, for example, a public switched telephone network, a wired local or wide area network, an intranet, the Internet, and wireless cellular, paging, local area, personal area, and short range networks such as those referred to as WiFi, IEEE 802.11a/b/g/n compatible networks, the short range wireless technology known as Bluetooth, and similar types of communication links.

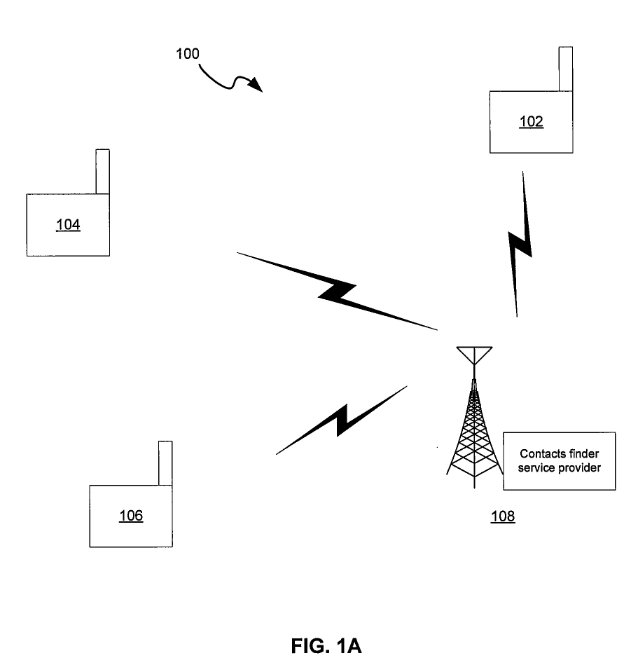

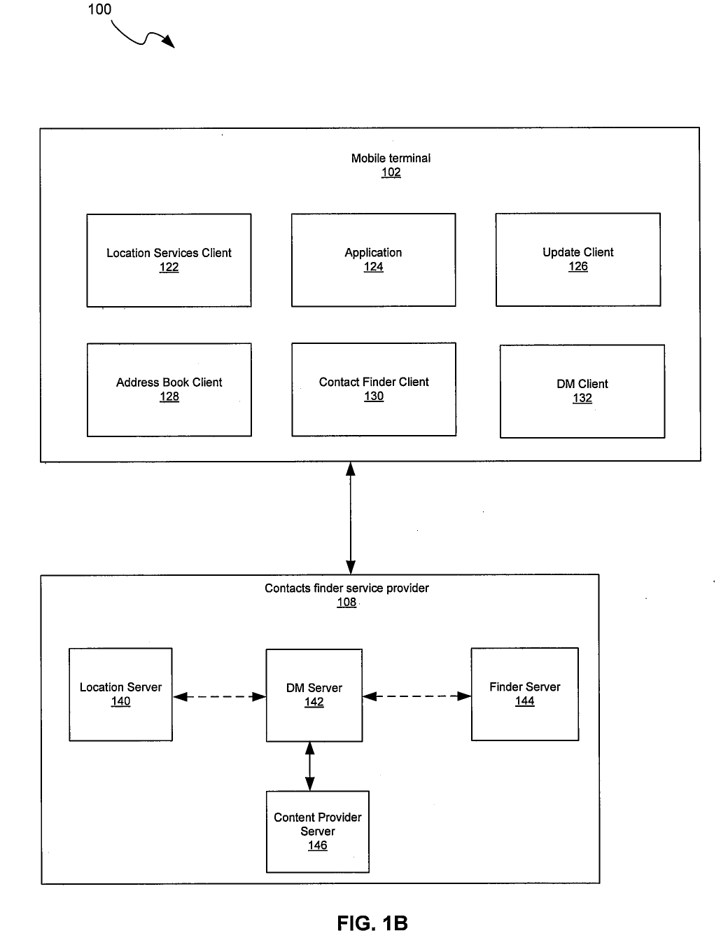

FIG. 1A is a diagram of an exemplary network that supports a contacts finder service, in accordance with an embodiment of the invention. Referring to FIG. 1A, there is shown a network 100 that comprises, in part, mobile terminals 102, 104, and 106, and a contacts finder service provider 108. The mobile terminal 102 may, for example, use the contacts finder service via the contacts finder service provider 108 to determine when one or both of the mobile terminals 104 and 106 may be within a certain range. The range may be a fixed range or the range may be determined by a user of the mobile terminal 102 and/or the contacts finder service provider 108. If the mobile terminals 104 and/or 106 are within range, the contacts finder service provider 108 may cause a display to appear on the mobile terminal 102 that shows where the mobile terminals 104 and/or 106 (and presumably, their users) are with respect to the user's mobile terminal 102. The users of the mobile terminals 104 and 106 may be contacts, or friends, of the user of the mobile terminal 102.

Various embodiments of the invention are further described with respect to FIGS. 1B-7.

FIG. 1B is a perspective block diagram of a network that is capable of supporting a contacts finder service, in accordance with an embodiment of the invention. Referring to FIG. 1B, there is shown the mobile terminal 102 and portions of a contacts finder service provider 108. The mobile terminal 102 may, for example, comprise a cellular phone, a personal digital assistant (PDA), a pager, a handheld personal computer (PC), and/or the like.

The mobile terminal 102 can comprise, for example, the location services client 122, the application 124, the update client 126, the address book client 128, the contact finder client 130, and the device management (DM) client 132. The location services client 122 may enable determining location of the mobile terminal 102. The location may be determined by one or more of a plurality of technologies. For example, some of the position location technologies are the global positioning system (GPS), assisted GPS (AGPS), enhanced observed time difference (E-OTD), and the time difference of arrival (TDOA).

The application 124 may refer to one or more applications that are resident on the mobile terminal 102. One of the applications could be, for example, the contacts finder application. The application 124 may also, for example, control displaying of a menu that lists the various applications that are resident on the mobile terminal 102. The application 124 may be suitable for updating a list of applications from which a user can select as applications get deleted or added. Some examples of the various applications are playing MP3 files, viewing TV or video, and playing games.

The update client 126 may enable downloading updates to firmware and/or software for the mobile terminal. The updates may be for the applications and/or the operating system of the mobile terminal 102. The address book client 128 may enable entering, deleting, changing, and otherwise managing various entries in the mobile terminal 102. the entries may comprise a name, phone number, email address, street address, etc. The address book client may interface with other components of the mobile terminal 102 to, for example, display a nickname for an incoming call.

The contact finder client 130 may enable a user of the mobile terminal 102 to register with the contacts finder services provider 108, and to locate contacts that are within a certain range of the mobile terminal 102. The range for locating contacts may be fixed by the contacts finder services provider 108 or selected by the user of the mobile terminal 102. The DM client 132 of the mobile terminal 102 may interact with the contacts finder services provider 108 to receive DM commands and to implement them in the mobile terminal 102.

The portions of the contacts finder service provider 108 illustrated in FIG. 1B are a location services server 140, a DM server 142, a finder server 142, and a content provider server 144. Although not illustrated in FIG. 1B, an embodiment of the invention may also comprise other application servers such as, for example, a diagnostics server, and a self-care website/portal.

The location server 140 may enable communicating with the mobile terminal's carrier network to retrieve the mobile terminal's location. This may be necessary, for example, when the mobile terminal does not have the capability to determine its location. The mobile terminal may instead provide information to its carrier network and the carrier network may determine the mobile's location. This may comprise, for example, the mobile terminal communicating to the carrier network the times that a particular transmission may have been received from several base stations (not shown). The carrier network may then triangulate the position of the mobile terminal 102.

The DM server 142 may comprise functionality required to communicate DM commands to the mobile terminals 102, 104, and/or 106. The DM server 142 may also support the Open Mobile Alliance (OMA) DM protocol, by which the OMA DM-based application manipulates OMA DM-capable electronic devices such as, for example, the mobile terminals 102, 104, and/or 106.

The finder server 144 may enable communicating with the user's mobile terminal 102 and with the mobile terminals 104 and 106 to determine when a specified contact may be within range of the user. The finder server 144 may get the location information directly from the mobile terminals or from the location server 140. The content provider server 146 may enable providing, for example, user-specific advertisements and/or promotions based on a user's preferences. Various embodiments of the invention may involve asking a user to state various preferences, such as, hobbies, preferred stores for shopping for specific items, etc.

Although not shown, databases may be used to store various information, including user information. The databases may be a distributed database system spread out among various servers, or the databases may be centrally located on one server. The database implementation may be design dependent.

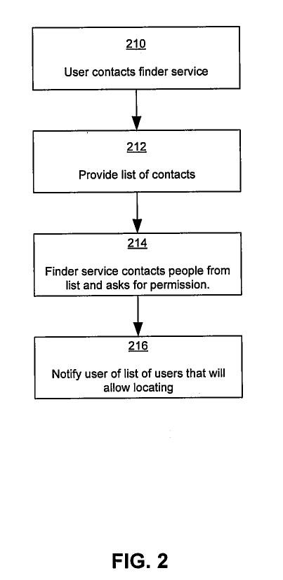

FIG. 2 is a flow chart of exemplary steps for using a contacts finder service, in accordance with an embodiment of the invention. Referring to FIG. 2, there is shown steps 210 to 220. In step 210, a user of an electronic device, for example, the mobile terminal 102, may communicate with the contacts finder service to locate specific people that may be near the user. In step 212, the user may provide a contact list to the contacts finder service. The contact list may be from, for example, the phonebook list in the mobile terminal 102 and/or information entered by the user.

In step 214, the contacts finder service will communicate with each member of the contact list to determine whether those people wish to be part of the contact list. Those who agree to be part of the contact list will allow their location to be tracked by the contacts finder service. The contacts finder service can then communicate to the mobile terminal 102 which contacts may be within a specified range of the mobile terminal. The specified range can be, for example, a default value, or set by the user and/or the contacts finder service.

In step 216, the contacts finder service may also, for example, inform the user of the mobile terminal 102 of the people who did not want to be part of the contact list, who gave permission to be part of the contact list, and those from whom a final decision is still pending.

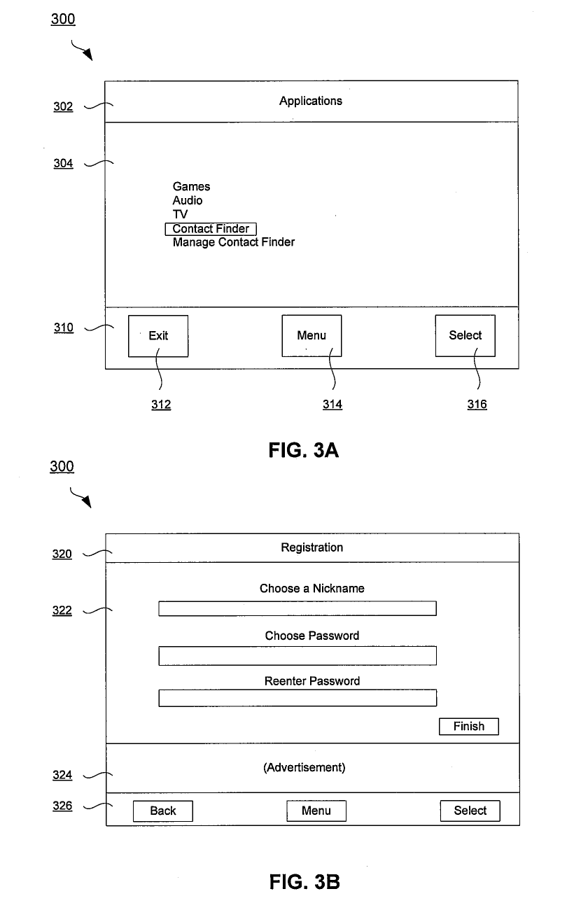

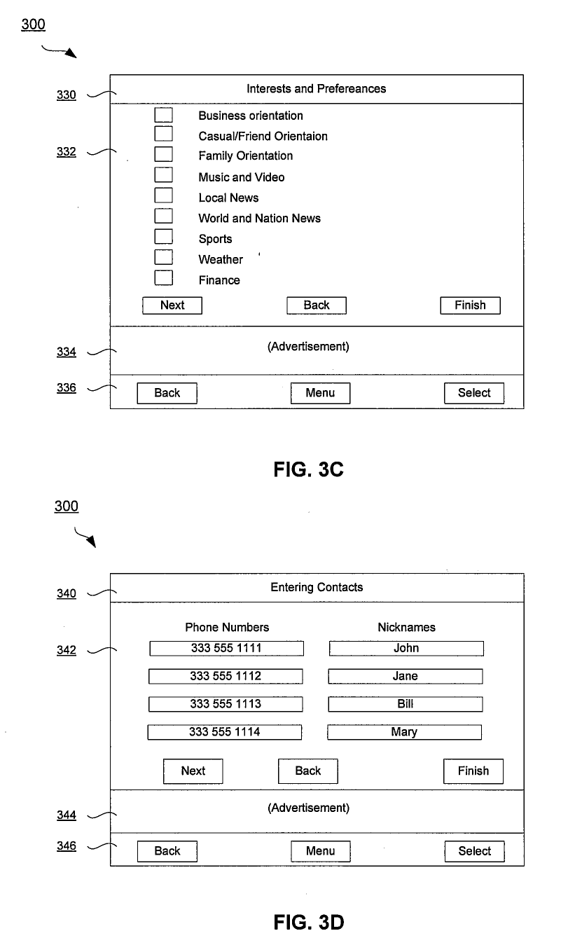

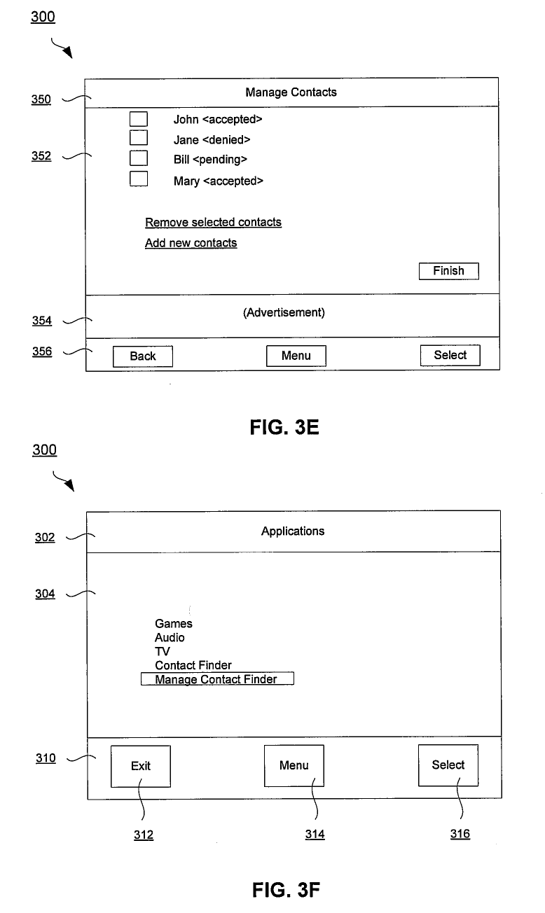

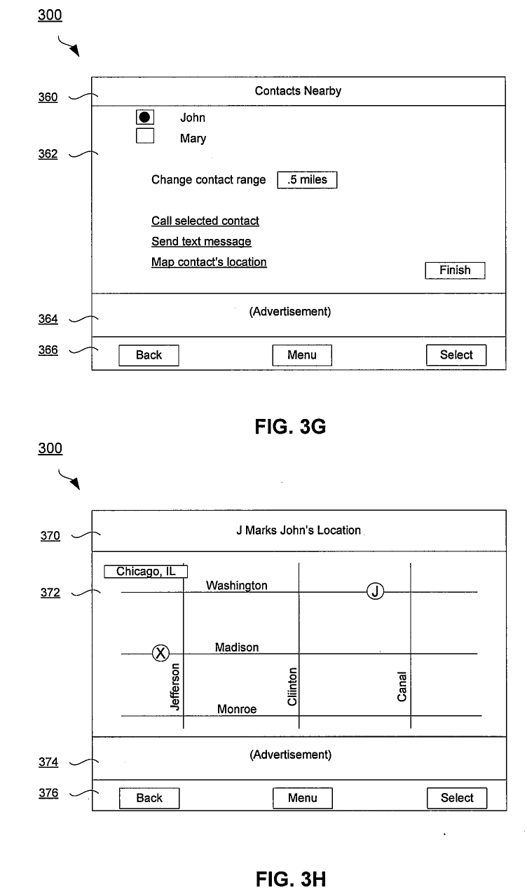

FIG. 3A is a perspective block diagram of an exemplary menu for use with a contacts finder service, in accordance with an embodiment of the invention. Referring to FIG. 3A, there is shown an exemplary mobile terminal screen 300. The exemplary mobile terminal screen 300 may display, for example, an applications menu that may comprise a title bar 302, a list of applications 304, and an options field 310. The options field 310 can comprise, for example, an Exit choice 312, a Menu choice 314, and a Select choice 316. Selecting the Exit choice 312 may allow exiting from the applications menu. Selecting the Menu choice 314 may display further menus, if applicable. For example, selecting Games from the list of applications 304 and then selecting the Menu choice may display available games. Selecting the Select choice may run a particular application selected. For example, a user that wishes to start a contact list can select the “Contact Finder” choice and then press the “Select” option.

Other embodiments of the invention may display further menus or run an application when the application is selected. The application may be selected, for example, by clicking on the particular application in the application list 304.

FIG. 3B is a perspective block diagram of an exemplary registration menu for use with a contacts finder service, in accordance with an embodiment of the invention. Referring to FIG. 3B, there is shown the exemplary mobile terminal screen 300. The exemplary mobile terminal screen 300 may display, for example, a registration menu that comprises various fields that may be displayed after the “Contact Finder” application is selected.

The exemplary mobile terminal screen 300 comprises, for example, the title bar 320 that indicates that this is menu is a “Registration” menu, the information field 322, the advertisement field 324, and the options field 326.

The user of the mobile terminal 322 can enter his nickname and a password. The password should be re-entered to verify that the password is entered correctly. If the two passwords do not match, the user will be prompted to re-enter the password. When the user is finished with entering information for the information field 322, the user can press the “Finish” button in the information field 322. Additionally, the contacts finder service may download advertisement information to the mobile terminal 102 so that advertisements can be displayed in the advertisement field 324.

FIG. 3C is a perspective block diagram of an exemplary preferences menu for use with a contacts finder service, in accordance with an embodiment of the invention. Referring to FIG. 3C, there is shown the exemplary mobile terminal screen 300. The exemplary mobile terminal screen 300 may display, for example, a preferences menu that comprises various fields that may be displayed after the user is finished with “Registration” menu.

The exemplary mobile terminal screen 300 can comprise, for example, the title bar 320 that indicates that this is menu is an “Interests and Preferences” menu, the information field 332, the advertisement field 334, and the options field 336.

The user of the mobile terminal 102 can select one or more items displayed in the information field 332 that may indicate his interests. This information can be used to tailor the advertisements downloaded to the user's mobile terminal. There can also be buttons that will allow the user to navigate to different screens if there is too much “Interests and Preferences” information to show on one screen. This can be implemented with, for example, “Back” and “Next” buttons and/or a navigation bar that will scroll the screen.

FIG. 3D is a perspective block diagram of an exemplary contact entry menu for use with a contacts finder service, in accordance with an embodiment of the invention. Referring to FIG. 3D, there is shown the exemplary mobile terminal screen 300. The exemplary mobile terminal screen 300 may display, for example, a contacts entry menu that comprises various fields that may be displayed after the user is finished with the “Interests and Preferences” menu.

The exemplary mobile terminal screen 300 can comprise, for example, the title bar 340 that indicates that the user is now in a menu “Entering Contacts,” the information field 342, the advertisement field 344, and the options field 346.

The user of the mobile terminal 102 can enter information for the people that he wishes to be a part of his contact list. The information can be entered manually or the information can comprise all or a portion of the people in the phonebook for the mobile terminal 102. An option may be to take information that may be tagged as being mobile. For example, some phone books allow a phone number to be tagged as a home number, a work number, or a mobile number.

The user of the mobile terminal 102 may also be able to scroll through the phone book to select contacts and information for inclusion in the contact list. Since the amount of information that can be displayed on a mobile terminal menu can be limited, the user can select different screens to be able to enter more contacts. This can be implemented with, for example, “Back” and “Next” buttons and/or a navigation bar that will scroll the screen.

FIG. 3E is a perspective block diagram of an exemplary contact management menu for use with a contacts finder service, in accordance with an embodiment of the invention. Referring to FIG. 3E, there is shown the exemplary mobile terminal screen 300. The exemplary mobile terminal screen 300 may display, for example, a contact management menu that comprises various fields that may be displayed after the user is finished entering information for the desired contact in the “Entering Contacts” menu.

The exemplary mobile terminal screen 300 may display, for example, the title bar 350 that indicates that the user is now in “Manage Contacts” menu, the information field 352, the advertisement field 354, and the options field 356.

The information field 352 can display the people in the contact list that was entered in the “Entering Contacts” menu described with respect to FIG. 3D. The information field 352 can display the status of each name in the contact list, and whether that person granted permission to remain in the contact list, or denied permission to remain in the contact list. People who have not granted or denied permission, yet, may also be displayed.

Once all the people in the contact list have answered the request for permission to remain in the contact list, the user of the mobile terminal 102 can press the “Finish” button. If the user wishes to remove selected people from the contact list, the user can select the “Remove selected contacts” choice and then press “Remove checked contacts” to remove those people from the contact list. The user can also press the “Add new contacts” choice to be able to add to the contact list. This choice may lead to “Entering contacts” menu.

If the contact list cannot be displayed in one screen, the user of the mobile terminal 102 may also be able to change views using, for example, “Back” and “Next” buttons and/or a navigation bar that will scroll the screen.

FIG. 3F is a perspective block diagram of an exemplary menu for use with a contacts finder service, in accordance with an embodiment of the invention. Referring to FIG. 3F, there is shown the exemplary mobile terminal screen 300. The exemplary mobile terminal screen 300 may display, for example, the application menu described with respect to FIG. 3A. The user, who may wish to check to see if certain members of his contact list are near him, may select “Manage Contact Finder.”

FIG. 3G is a perspective block diagram of an exemplary menu that displays nearby contacts, in accordance with an embodiment of the invention. Referring to FIG. 3G, there is shown the exemplary mobile terminal screen 300. The exemplary mobile terminal screen 300 may display a menu that comprises a title bar 360 that may display “Contacts Nearby,” the information field 362, the advertisement field 364, and the options field 366. The “Contacts Nearby” menu may be displayed, for example, in response to selection of “Manage Contact Finder” option from the applications screen in FIG. 3F.

The exemplary mobile terminal screen 300 may display, for example, the title bar 360 that indicates that the user is now in “Contacts Nearby” menu, the information field 362, the advertisement field 364, and the options field 366. The information field 362 can display the people in the contact list that have given permission to be in the contact list and who are within a specified range. The range may have a default value, and that range can be changed by the user or the contacts finder service. The user of the mobile terminal 102 can then select a person by, for example, clicking the box next to the person's name. The user can then choose, for example, whether to call the selected person, send a text message to the selected person, or map a location of the selected person.

Various embodiments of the invention may also allow mapping the positions of all the contacts, or some of the contacts, who may be within a specified range. Various embodiments of the invention may also allow a common text message to be sent to each of the contacts with the specified range.

FIG. 3H is a perspective block diagram of an exemplary menu displaying a location of a nearby contact, in accordance with an embodiment of the invention. Referring to FIG. 3H, there is shown the exemplary mobile terminal screen 300 that may comprise a title bar 370 that displays, for example, “J Marks John's Location,” the information field 372, the advertisement field 374, and the options field 376. The title bar 370 can be implemented to display the name of the person whose location is being mapped. John may be the person selected with respect to FIG. 3G for location mapping. The information field 372 may display a map that may indicate a location for the user of the mobile terminal 102 and a location for the selected contact or contacts.

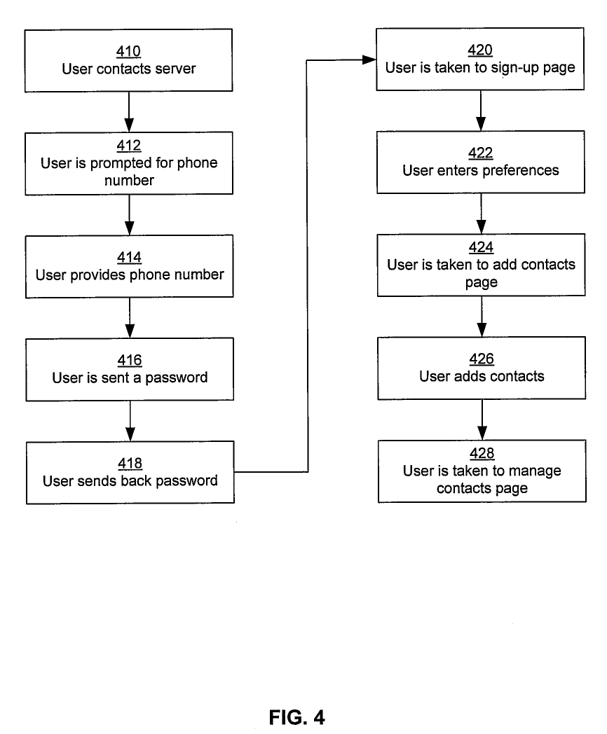

FIG. 4 is a flowchart of an exemplary method to register a new user, in accordance with an embodiment of the invention. Referring to FIG. 4, there is shown steps 410 to 428. In step 410, the user of the mobile terminal 102 can contact the contacts finder service by selecting, for example, “Contact Finder” in the application selection menu as shown with respect to FIG. 3A. In step 412, the contacts finder service may prompt the user for a phone number that may be associated with, for example, the mobile terminal 102. In step 414, the user may provide the phone number to the contacts finder service.

In step 416, the user may be sent a password. In step 418, the user sends back the password to verify that the user received the correct password. Various embodiments of the invention may allow the user to change the password at a later time as part of managing his account.

In step 420, the user is then taken to a preferences page such as, for example, the “Interests and Preferences” menu described with respect to FIG. 3C. It may be noted that the steps 412 to 418 are different than the process described with respect to FIG. 3B. The differences are due to descriptions of different implementations that can be used for various embodiments of the invention for registering a new user.

In step 422, the user may enter his preferences. These preferences may be used to tailor advertisements and promotions downloaded to the user's mobile terminal 102. In step 424, the mobile terminal 102 may display a page where the user can enter contacts for his contact list. In step 426, the user can add entries to the contact list using, for example, the “Entering Contacts” menu described with respect to FIG. 3D.

In step 428, the mobile terminal may display a page where the user may be able to see the status of the individual entries of his contact list. The contacts finder service provider 108 may communicate with each person in the contact list to solicit permission to keep that person in the contact list. The user of the mobile terminal 102 may be notified whether each person in the contact list gave permission, denied permission, or permission is still pending.

The registration described with respect to FIG. 4 may take place using, for example, OMA DM and/or browser technology.

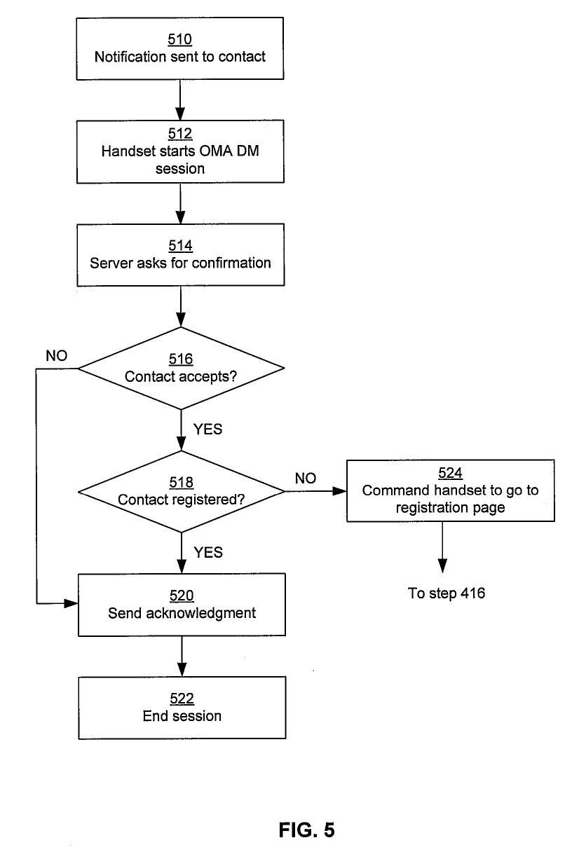

FIG. 5 is a flowchart of an exemplary method to verify a contact list for a user, in accordance with an embodiment of the invention. Referring to FIG. 5, there is shown steps 510 to 524. In step 510, the contacts finder service provider 108 will notify one or more of the listed entries in the contact list generated by the user of the mobile terminal 102 to start an OMA DM session. In step 512, a DM client, such as, for example, the DM client 132, in the contact's mobile terminal, such as, for example, the mobile terminal 104, may start an OMA DM session.

In step 514, the contacts finder service provider 108 may then query whether the contact wishes the user of the mobile terminal 102 to be able to keep track of the location of the contact's mobile terminal 104. The DM session for the contacts finder service provider 108 may be managed by, for example, the DM server 142. In step 516, if the contact grants permission, the next step may be step 518. Otherwise, the next step may be step 520.

In step 518, the contacts finder service provider 108 may determine whether the contact that gave permission may be registered with the contacts finder service provider 108. If so, the next step may be step 520. Otherwise, the next step may be step 524.

In step 520, the contacts finder service provider 108 may send an acknowledgment to the contact. For example, if the contact declined to give permission, the acknowledgment may indicate that the contacts finder service provider 108 will not keep track of the location of the contact's mobile terminal 104. The DM server 142 will also indicate that the DM session is finished. Otherwise, if the contact did give permission, the acknowledgment may indicate that the contacts finder service provider 108 may keep track of the contact's mobile terminal 104, as needed. The DM server 142 will also indicate that the DM session is finished. In step 522, the contact's mobile terminal 104 will end the DMA OM session.

In step 524, since the contact is not registered with the contacts finder service provider 108, the contact's mobile terminal 104 may display the registration menu, where the menu may be substantially as described with respect to FIG. 3B. Accordingly, the next step may be, for example, step 416 since the user has already entered the phone number for the contact.

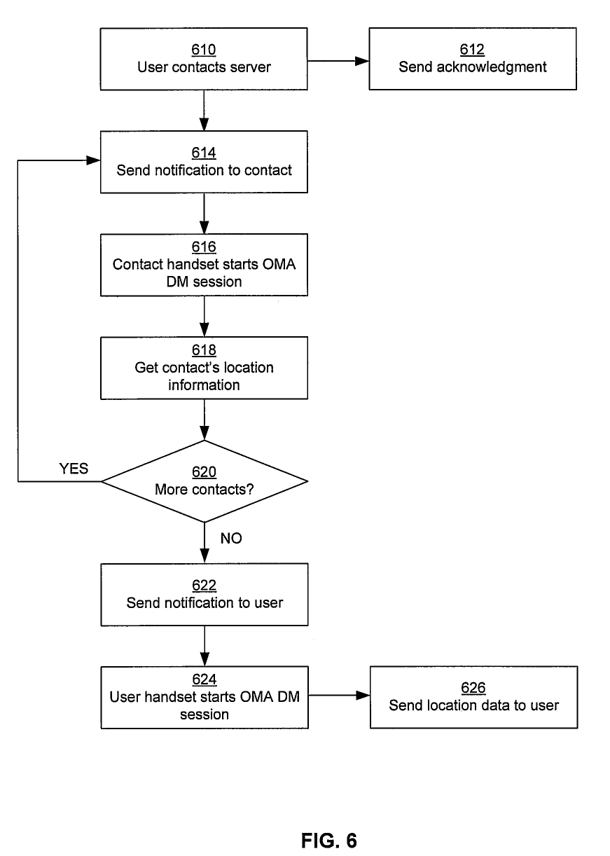

FIG. 6 is a flowchart of an exemplary method for a user to determine whether any contacts are nearby when the contact is able to determine its own position, in accordance with an embodiment of the invention. Referring to FIG. 6, there is shown steps 610 to 626. In step 610, the user of the mobile terminal 102 will contact the contacts finder service provider 108 to determine whether one or more contacts from the contact list may be nearby. Some embodiments of the invention may require a separate transaction for locating each contact, while some embodiments of the invention may allow a single transaction to locate one or more contacts. In step 612, the contacts finder service provider 108 will respond to the user with a request acknowledgment.

In step 614, the contacts finder service provider 108 will send a notification to the contact's mobile terminal 104 to start an OMA DM session. In step 616, the contact's mobile terminal 104 will start an OMA DM session. The OMA DM session may be managed by, for example, the DM client 132 of the contact's mobile terminal 104 and the DM server 142 of the contacts finder service provider 108.

In step 618, the contacts finder service provider 108 may receive the information regarding the location of contact's mobile terminal 104. For example, if the contact's mobile terminal 104 comprises capability to determine its location, the information communicated to the contacts finder service provider 108 may be its location. The contact's mobile terminal 104 may use, for example, GPS or E-OTD to determine its location. The finder server 144 may receive the location information.

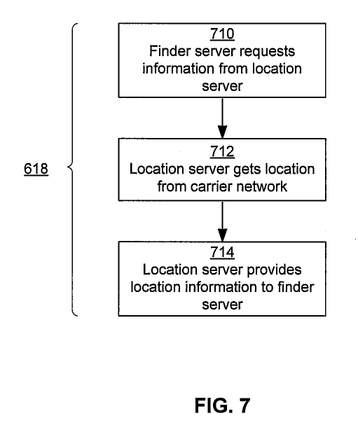

If the contact's mobile terminal 104 does not comprise the ability to determine its location, the contacts finder service provider 108 may communicate with the carrier network of the contact's mobile terminal 104 to determine its position. The contact's mobile terminal 104 may use, for example, AGPS or TDOA, and forward information from the particular system used for the contacts finder service provider 108 to determine the location. The contacts finder service provider 108 and the contact's mobile terminal 104 may then end the OMA DM session. This is discussed with respect to FIG. 7.

In step 620, the contacts finder service provider 108 may determine if location information for other contacts, such as, for example, the mobile terminal 106, may be needed, if locations for multiple contacts are supported. If so, the next step may be step 614 where other contacts may be notified. Otherwise, the next step may be step 622.

In step 622, the contacts finder service provider 108 will send a notification to the user's mobile terminal 102 to start an OMA DM session. In step 624, the user's mobile terminal 102 will start an OMA DM session. In step 626, the location data for one or more of the contacts will be sent to the user's mobile terminal 102 by the contacts finder service provider 108. Accordingly, the user's mobile terminal 102 can display a map with the positions of the contacts located on the map.

FIG. 7 is a flowchart of an exemplary method for determining location of a nearby contact when the contact is not able to determine its own position, in accordance with an embodiment of the invention. Referring to FIG. 7, there is shown steps 710 to 714, which may be equivalent to the step 618 for cases when a mobile terminal is not able to determine its own position. This may apply to those instances where the mobile terminal depends on its carrier's network to determine its position. This may be, for example, because the carrier uses a positioning technology such as, for example, AGPS or TDOA.

In step 710, the finder server 144 may determine that the mobile terminal 104 does not have its location information. Accordingly, the finder server 144 will request the location information for the mobile terminal 104 from the locator server 140. In step 712, the locator server 140 will communicate with the carrier network to determine the location of the mobile terminal 104. In step 714, the location server 140 will provide the location information of the mobile terminal 104 to the finder server 144.

Although a system and method according to the present invention has been described in connection with the preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for interfacing to an electronic device, the method comprising:
receiving a request from the electronic device to find one or more specified mobile terminals that are within a specified range of the electronic device;
determining whether said one or more specified mobile terminals are within said specified range of the electronic device; and
communicating information regarding said one or more specified mobile terminals that are within said specified range to the electronic device.

2. The method according to claim 1, wherein the electronic device is a mobile terminal.

3. The method according to claim 1, wherein said specified range is specified by a service provider that receives said request.

4. The method according to claim 1, wherein said specified range is specified by a user of the electronic device.

5. The method according to claim 1, wherein, if any of said one or more specified mobile terminals are within said specified range of the electronic device, said communicated information comprises map information for locating said one or more specified mobile terminals that are within said specified range of the electronic device, on a map.

6. The method according to claim 1, wherein said communicated information comprises map information for locating the electronic device on a map.

7. The method according to claim 1, comprising receiving from the electronic device a list of mobile terminals from which to select said one or more specified mobile terminals.

8. The method according to claim 7, comprising requesting, by a service provider, from a user of each mobile terminal in said list of mobile terminals, permission to keep said each mobile terminal in said list of mobile terminals.

9. The method according to claim 8, comprising, if said user of said each mobile terminal granted said permission, registering said each mobile terminal with said service provider.

10. The method according to claim 1, comprising registering the electronic device with a service provider that communicates said information, prior to determining whether said one or more specified mobile terminals are within said specified range of the electronic device.

11. A system for interfacing to an electronic device, the system comprising:
one or more servers that enable processing of a request from the electronic device to find one or more specified mobile terminals that are within a specified range of the electronic device;
said one or more servers enable determination of whether said one or more specified mobile terminals are within said specified range of the electronic device; and
said one or more servers enable communication of information regarding said one or more specified mobile terminals that are within said specified range to the electronic device.

12. The system according to claim 11, wherein the electronic device is a mobile terminal.

13. The system according to claim 11, wherein said specified range is a default value.

14. The system according to claim 11, wherein said specified range is specified by a user of the electronic device.

15. The system according to claim 11, wherein, if any of said one or more specified mobile terminals are within said specified range of the electronic device, said communicated information comprises map information for locating said one or more specified mobile terminals that are within said specified range of the electronic device, on a map.

16. The system according to claim 11, wherein said communicated information comprises map information for locating the electronic device on a map.

17. The system according to claim 11, wherein said one or more servers enable receiving from the electronic device, a list of mobile terminals from which to select said one or more specified mobile terminals.

18. The system according to claim 17, wherein said one or more servers enable requesting from a user of each mobile terminal in said list of mobile terminals, permission to keep said each mobile terminal in said list of mobile terminals.

19. The system according to claim 18, wherein said one or more servers enable registration of said each mobile terminal if said user of said each mobile terminal granted said permission.

20. The system according to claim 11, wherein said one or more servers enable registration of the electronic device, prior to determining whether said one or more specified mobile terminals are within said specified range of the electronic device.
